(19) United States
(12) Patent Application Publication
(10) Pub. No.: US 2007/0084644 A1
(43) Pub. Date: Apr. 19, 2007

(54) TOUCH SENSING APPARATUS

(75) Inventors: Shin-Hong Chung, Shenzhen (CN); Han-Che Wang, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,833

(22) Filed: Oct. 9, 2006

(30) Foreign Application Priority Data
Oct. 14, 2005 (TW) 094136013

(51) Int. Cl. G08C 21/00; G08B 13/26; G08B 21/00

(52) U.S. Cl. 178/18.06; 340/562; 340/686.6

(57) ABSTRACT

A preferred embodiment of a touch sensing apparatus includes an amplifier, an alternating current (AC) signal source, a sensor, a detector, a first load circuit, and a second load circuit. The alternating current (AC) signal source is for outputting AC signals to a first input and a second input of the amplifier. The sensor is for receiving electricity signals from an object that touches the sensor. The detector is for identifying a touch on the sensor according to output of the amplifier. The sensor and the first load circuit and the second load circuit, enable the amplifier has a common mode (CM) input when the sensor is not touched by the object. The sensor receives electricity signals from the object and enables the amplifier has a differential mode input. The amplifier amplifies a difference between the first input and the second input thereof and outputting the amplified difference to the detector.

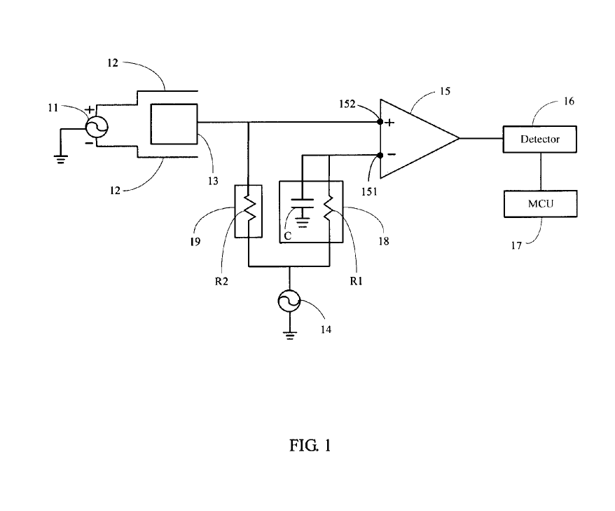

### FIELD OF THE INVENTION

The present invention relates generally to touch sensing apparatuses, and particularly to a touch sensing apparatus for sensing electricity signals of an object.

### DESCRIPTION OF RELATED ART

There are several available types of touch-sensing apparatuses that may be employed as positional indicators in apparatus such as personal computers. Among them, resistive-membrane positioning sensors and capacitive positioning sensors are well known and typically used in several applications. However, the resistive-membrane positioning sensors generally have poor resolutions. In addition, surfaces of the resistive-membrane positioning sensors are often exposed to the air, and therefore are easily worn out. Furthermore, resistive-membrane positioning sensors are relatively expensive.

A capacitive positioning sensor typically includes a substrate which supports a first and second interleaved, closely spaced, non-overlapping arrays of conductive plates. An insulating layer overlies the first and the second arrays. When an outer surface of the insulating layer is touched, the capacitances of at least one of the columns of plates of the first array and one of the rows of plates of the second array underlying the insulating layer at a location being touched exhibits a change with respect to ambient ground. Based upon the measured capacitance of each column of the first array and each row of the second array, a microcomputer produces output signals representing the coordinates of the location being touched. These output signals can be used, for example, to control a position of a cursor on a display screen of a personal computer or to make a selected function command. Although the capacitive positioning sensor has been designed to avoid being exposed to the air and thereby to avoid being easily worn out, however, by overlying the insulating layer thereon, the sensitivity of the touch sensing apparatus is reduced.

What is still needed is a touch sensing apparatus with reduced circuitry complexity, improved sense sensitivity, improved efficiency, and lower manufacturing costs.

### SUMMARY OF INVENTION

A touch sensing apparatus is provided. A preferred embodiment of a touch sensing apparatus includes an amplifier, an alternating current (AC) signal source, a sensor, a detector, a first load circuit, and a second load circuit. The amplifier has a first input and a second input. The alternating current (AC) signal source is for outputting AC signals to the first input and the second input of the amplifier. The sensor 13 is electrically connected to the first input of the amplifier and for receiving electricity signals from an object that touches the sensor. The detector is for identifying a touch on the sensor according to output of the amplifier. The first load circuit is connected between the AC signal source and the first input of the amplifier. The second load circuit is connected between the AC signal source and the second input of the amplifier. The sensor and the first load circuit and the second load circuit, enable the amplifier has a common mode (CM) input when the sensor is not touched by the object. The sensor receives electricity signals from the object and enables the amplifier has a differential mode input. The amplifier amplifies a difference between the first input and the second input thereof and outputting the amplified difference to the detector.

Other advantages and novel features will be drawn from the following detailed description of the preferred embodiment with reference to the attached drawings, in which:

### BRIEF DESCRIPTION OF DRAWINGS

The drawing is an exemplary circuit diagram of a touch sensing apparatus in accordance with a preferred embodiment of the present invention.

### DETAILED DESCRIPTION

The drawing is an exemplary circuit diagram of a touch sensing apparatus. The apparatus mainly includes a differential signal source 11, two conductors 12, a sensor 13, an alternating current (AC) signal source 14, an amplifier 15, a detector 16, a microcontroller unit (MCU) 17, a first load circuit 18, and a second load circuit 19.

The differential signal source 11 has a positive output and a negative output, each output connecting to an end of the conductors 12 correspondingly. The sensor 13 is located between the conductors 12, and forms two parallel-arranged capacitors with the conductors 12. The sensor 13 is electrically connected to either a non-inverting input or an inverting input of the amplifier 15. In the drawing, the sensor 13 is shown connecting with a non-inverting input 152 of the amplifier 15 as an example.

The differential signal source 11 outputs a positive signal and a negative signal via the positive output and the negative output thereof respectively. Generally, environmental noises are generated in an environment with charged bodies such as electric lights or computers. The environment noises are AC signals with irregular waveforms. When the environment noises reach the parallel-arranged capacitors, positive half-waves and negative half-waves of the environment noises are respectively offsetted by the positive signal and the negative signal outputted by the differential signal source 11. The touch sensing apparatus is therefore being protected from being disturbed by the environmental noises and improves a sensitivity thereof.

The AC signal source 14 is interposed among the ground and the first and second load circuits 18 and 19. The AC signal source applies AC signals to the first and second load circuits 18 and 19. The first load circuit 18 is interposed between the AC signal source 14 and an inverting input 151 of the amplifier 15 while the second load circuit 19 is interposed between the AC signal source 14 and the non-inverting input 152 of the amplifier 15. The first load circuit 18 and the second load circuit 19 each includes load component such as a resistor, a capacitor, and/or an inductor. The load components are chosen and arranged such that, when the sensor 13 is not touched, the amplifier 15 has an identical potential at the inverting input 151 and the non-inverting input 152 thereof. That is, the amplifier 15 has a common mode (CM) input. The amplifier 15 therefore has no output. In this preferred embodiment, the first load circuit 18 includes a capacitor C and a first resistor R1. Wherein the first resistor R1 is connected between the AC signal source 14 and inverting input 151 of the amplifier 15 and the capacitor C is connected between the ground and the inverting input 151 of the amplifier 15. While the second load circuit 19 only includes a second resistor R2 interposed between the AC signal source 14 and the non-inverting input 152 of the amplifier 15.

Generally, charged bodies can create alternating magnetic fields around themselves. When an electrical conducting object such as a human body moves into such an alternating magnetic field, inductive charges are generated and distributed on surfaces of the electrical conducting object, thus, improving electricity signals of the electrical conducting object. In the preferred embodiment, the differential signal source 11 provides such an alternating magnetic field improving the electricity signals of the electrical conducting object that touches the sensor 13.

The sensor 13 and the ground form a capacitor. When the electrical conducting object touches the sensor 13, the inductive charges on the electrical conducting object flow to the sensor, thus causing a change in capacitance of the capacitor, resulting in a change in capacitance of the non-inverting input 152 of the amplifier 15. The potential at the non-inverting input 152 of the amplifier 15 is unbalanced relative to the inverting input 151 of the amplifier 15, and the amplifier 15 has a differential mode (DM) input. The difference between the inverting and the non-inverting inputs are amplified and outputted by the amplifier 15 to the detector 16. The detector 16 detects such a difference, identifies a touch by the objects on the sensor 13 and signals the MCU 17. The MCU 17 therefore performs a procedure corresponding to the touch of the object on the sensor 13.

Although the present invention has been specifically described on the basis of a preferred embodiment, the invention is not to be construed as being limited thereto. Various changes or modifications may be made to the embodiment without departing from the scope and spirit of the invention.

What is claimed is:

1. A touch sensing apparatus comprising:
an amplifier having a first input and a second input;
an alternating current (AC) signal source for outputting AC signals to the first input and the second input of the amplifier; a sensor connected to the first input of the amplifier and for receiving electricity signals from an object that touches the sensor;
a detector for identifying a touch on the sensor according to output of the amplifier;
a first load circuit connected between the AC signal source and the first input of the amplifier; and
a second load circuit connected between the AC signal source and the second input of the amplifier;
wherein:
the sensor and the first load circuit and the second load circuit, enable the amplifier has a common mode (CM) input when the sensor is not touched by the object;
the sensor receives electricity signals from the object and enables the amplifier to have a differential mode input; and
the amplifier amplifies a difference between the first input and the second input thereof and outputting the amplified difference to the detector.

2. The touch sensing apparatus as described in claim 1, further comprising a microcontroller unit (MCU) connected to the detector and for performing a procedure corresponding to the touch of the object on the sensor.

3. The touch sensing apparatus as described in claim 1, further comprising a differential signal source with a positive output and a negative output, the differential signal source providing an alternating magnetic field for the touch sensing apparatus.

4. The touch sensing apparatus as described in claim 3, further comprising two conductors respectively connected to the positive output and the negative output of the differential signal source.

5. The touch sensing apparatus as described in claim 4, wherein the sensor is located between the two conductors and forms two simulated capacitors respectively with the two conductors for offsetting environmental noise.
